(19) United States
(12) Patent Application Publication
(10) Pub. No.: US 2007/0202750 A1
(43) Pub. Date: Aug. 30, 2007

(54) Card connector

(75) Inventors: Kenji Nishiwaki, Tokyo (JP); Osamu Miyamoto, Tokyo (JP)

Correspondence Address: TAKEUCHI & KUBOTERA, LLP, SUITE 202, 200 DAINGERFIELD ROAD, ALEXANDRIA, VA, 22314, US

(73) Assignee: Hirose Electric Co., Ltd.

(21) Appl. No.: 11/654,653

(22) Filed: Jan. 18, 2007

(30) Foreign Application Priority Data
Feb. 24, 2006 (JP) 2006-048089

(51) Int. Cl. H01R 24/00

(52) U.S. Cl. 439/630

(57) ABSTRACT

A card connector (1) includes a housing (10) having a card insertion opening at its front end into which a card (3) is inserted in a card insertion/removal direction and a metallic cover (30) for covering top and side faces of the housing (10). The housing has a pair of side walls (12a, 12b) extending in the card insertion/removal direction. The cover (30) has a protective member (70, 71) at the card insertion opening for protecting at least a portion of a front end of at least one of the side walls (12a, 12b).

### BACKGROUND OF THE INVENTION

1. Field of the Invention

The present invention relates to card connectors and, particularly, to a card connector with a protection against wrong card insertion.

2. Description of the Related Art

FIG. 10 shows a conventional card connector. This card connector 9 is disclosed in JP 2003-109694 and includes a housing 7, a plurality of terminals 5 arranged on the housing 7, and a metal cover 8 that covers the top and side faces of the housing 7 except for the card insertion side 15.

Where a card (not shown) is inserted into the connector 9 in a wrong direction, for instance, upside down, the card is inserted along the side walls 4a and 4b to a certain extent and then blocked from further insertion. If the card is pushed further into the inside, the contact or slider of the connector can be broken.

When the connector or card is miniaturized, it is difficult to distinguish the front and back sides of a card. Especially, when a compact card is inserted into a mobile device, such as a cell phone, this problem becomes worse because the mobile device itself can turn upside down.

Where a card is inserted at an angle, or forcibly inserted, the side wall 4a or 4b can be damaged. An extended portion 6 of the metal cover 8 is bent downwardly to cover an end face 5a of the housing 7 for reinforcement. This extended portion 6, however, is provided to attach the cover 8 to the housing 7 and fails to protect the rear end 5a or 5b of the side wall 4a or 4b from damage caused by wrong card insertion.

### SUMMARY OF THE INVENTION

Accordingly, it is an object of the invention to provide a card connector having high withstanding power against wrong card insertion.

According to the invention there is provided a card connector comprising a housing having a card insertion opening at its front end into which a card is inserted in a card insertion/removal direction and a metal cover for covering top and side faces of the housing. The housing has a pair of side walls extending in the card insertion direction. The cover has a protective member at the card insertion opening for protecting at least a portion of a front end of at least one of the side walls.

The protective member may have a portion that extends in the card insertion/removal direction and bent downwardly at the end of the side wall, or it may have a portion that extends in the card insertion/removal direction and bent laterally toward the card insertion opening at the end of the side wall. The protective member may be fixed to or engaged with another member.

The card may have an inclined face between a front narrow section and a rear wide section of the card. The card connector further comprises an ejector that is able to slide in the housing in the card nsertion/removal direction and normally biased toward the card insertion opening. The ejector may have an inclined face that corresponds to the inclined face of the card so that when the card is inserted correctly, it is inserted into the housing with the inclined face of the card fitting with the inclined face of the ejector while if the card is inserted upside down, the inclined face of the ejector abuts against another face of the card, making the card inclined and preventing wrong insertion of the card.

### BRIEF DESCRIPTION OF THE DRAWINGS

FIG. 1 is a perspective view of a card connector according to an embodiment of the invention;

FIG. 2 is a perspective view of a metal cover for the card connector;

FIG. 3 is a perspective view of the card connector from which the metal cover has been removed;

FIGS. 4a and 4b are a top plan view of the card connector, showing the inside condition upon card insertion;

FIG. 5 is a top plan view of the card connector showing wrong card insertion;

FIG. 6 is a perspective view of a first variation of the first protective member;

FIG. 7 is a perspective view of a variation of the second protective member;

FIG. 8 is a perspective view of a second variation of the first protective member;

FIG. 9 is a perspective view of a third variation of the first protective member; and

FIG. 10 is a perspective view of a conventional card connector.

### DESCRIPTION OF THE PREFERRED EMBODIMENTS

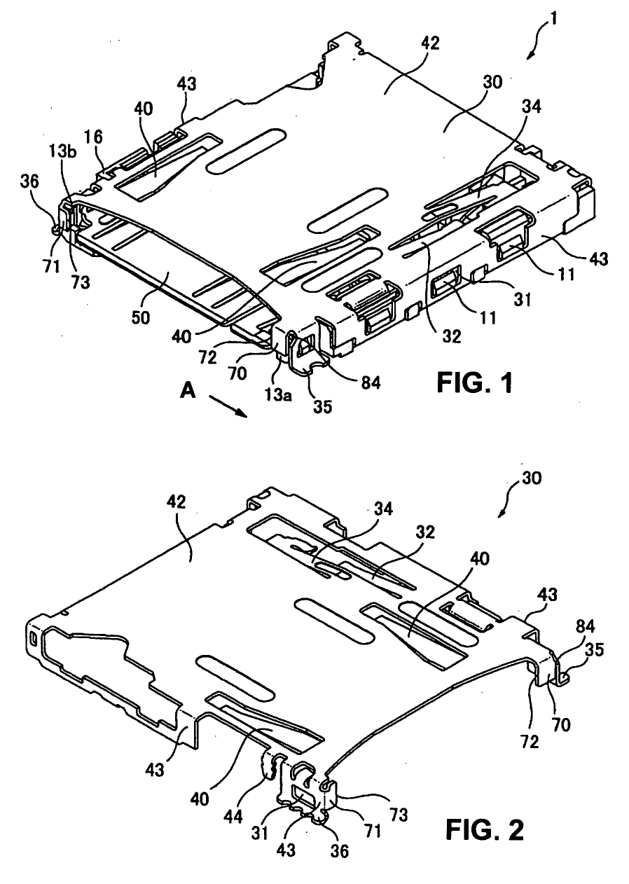

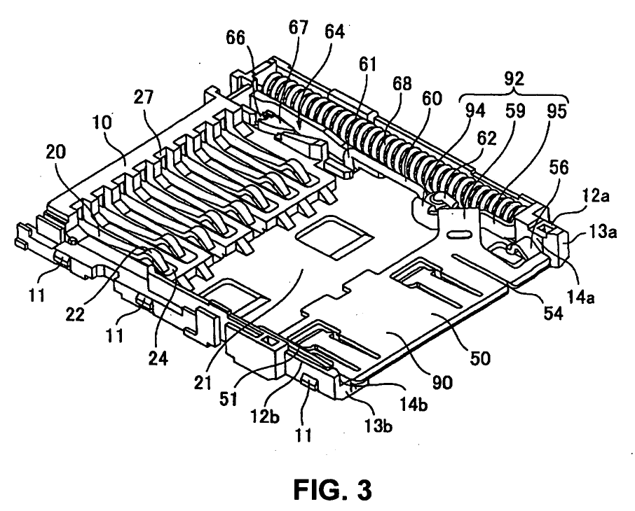

In FIGS. 1-4, a card connector 1 is a push-push type connector with an eject mechanism that a card 3 may be inserted or removed at will from the connector 1. The card 3 is a compact card such as mini-SD or micro-SD. The connector 1 is made compact according to the size of the card 3. The mold for a housing 10 of the connector 1 has a very thin wall and the strength of the housing 10 becomes critical.

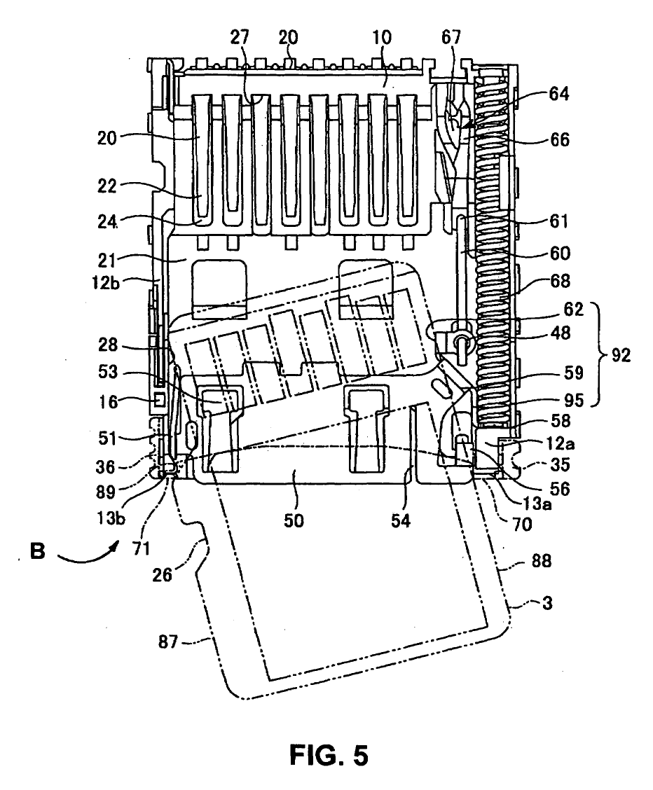

As shown in FIG. 5, where the card 3 is inserted into the connector 1 upside down, the side wall 88 of the card 3 is guided by a spring abutment 58 or the slope of a card abutment 59 so that the card 3 is inserted into the connector at an angle. Consequently, the side wall 88 or 89 of the card 3 abuts against the housing 10 near the card insertion opening. In this way, when the card is inserted upside down, it is inserted only to a midway of the housing. As a result, the wrong insertion is prevented. At this point, the side wall 87 or 88 of the inclined card 3 can damage the insertion opening of the housing 10. According to the invention, it is possible to prevent such damage to a side wall 12a and even wrong card insertion itself.

More specifically, the connector 1 includes a housing 10 made of an insulative material, such as a resin, a plurality of terminals 20 housed in the housing 10, an ejector 50, a pin 60, a spring 68, and a metal cover 30. After the components are assembled in the housing 10, the cover 30 is attached to the housing 10 to cover it except for the card insertion opening by press fitting a press-fit portion 44 of the cover 30 into a hole 16 of the housing 10 or engaging an engaging hole 31 of the cover 30 with an engaging projection 11 of the housing 10.

A plurality of terminal fixing holes 27 are provided in the rear face of the housing 10 so that terminals 20 are arranged along and between a pair of side walls 12a and 12b. When a card is inserted into the connector 1 along the side walls 12a and 12b, the curved terminal contacts 22 of the terminals 20 are brought into contact with the terminal portions (not shown) of the card 3. The terminal contacts 22 are moveable downwardly through terminal grooves 24. Alternatively, the side walls 12a and 12b may be made of a metal sheet.

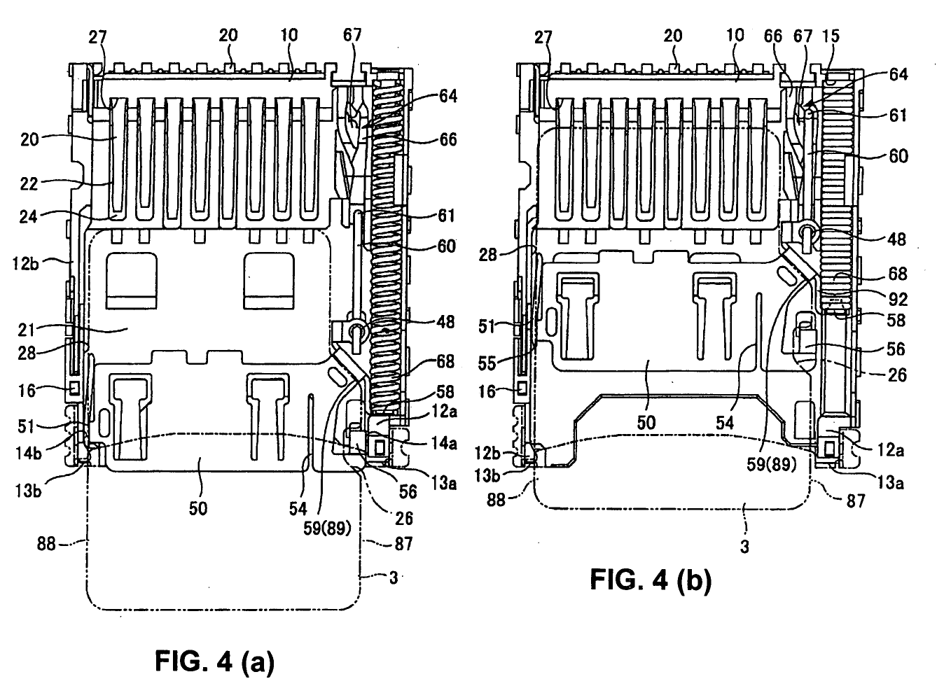

A metallic ejector 50 is provided on the front side of the housing 10. It is biased by a spring 68 toward the card insertion opening and is able to slide with the card 3 thereon in the card insertion/removal direction. It reciprocates between a pre-insertion position as shown in FIG. 4a and a lock position as shown in FIG. 4b. FIG. 4a shows the condition that the card 3 is put on the ejector 50 or that the card 3 is removed from the housing 10, when the contact between the card 3 and the terminals 20 has been released. FIG. 4b shows the locked position that the card 3 has been pushed into the housing 10 and locked at a predetermined position, where the card 3 is in contact with the terminals 20. If the card 3 is inserted in a wrong way but not at an angle, it is guided into the housing 10 by the side walls 12a and 12b to the position as shown in FIG. 4b.

The ejector 50 includes a plate section 90 and a pair of side walls 51 and 92 extending from opposite sides of the plate section 90 to the bottom face 21 of the housing 10. The side wall 92 includes a card abutment 59, and a rear extension 94 and a front extension 95.

When the card 3 is inserted into the connector 1 correctly, the card 3 slides on the plate section 90 of the ejector 50 and engages with the ejector 50 near its center. For positioning, the card 3 is provided on its side face 87 with an inclined face 89 between the front narrow section and the rear wide section. Correspondingly, the card abutment 59 of the ejector 50 is provided with an inclined face. A recess 26 is provided in the rear wide section of the card 3 and a lock spring 56 is provided on the ejector for engagement with the recess 26. The lock spring 56 is made by bending a portion of the plate section 90 in a triangle shape such that it is flexible downwardly to the bottom face of the ejector.

As shown in FIGS. 4a and 4b, when the card 3 is inserted correctly, it is inserted in the connector 1 without block by the card abutment 59 due to the presence of the front narrow section. When the card 3 is further inserted, the card abutment 59 abuts against the lock spring 56 but the card 3 is not inclined because the side walls 87 and 88 of the card 3 are guided by the side walls 12a and 12b. Then, the card 3 deflexes the lock spring 56 downwardly and, when the lock spring 56 reaches the recess 26 of the card 3, the inclined face 89 of the card 3 abuts against the inclined face of the card abutment 59 and the lock spring 56 snaps into the recess 26 of the card 3. The resiliency of the side wall 51 allows perfect fitness between the inclined face 89 of the card 3 and the card abutment 59 so that the card 3 is positioned on the plate section 90 of the ejector 50. This engagement of the card 3 by the lock spring 56 is released readily by pulling back the card 3. In order to facilitate replacement of the lock spring 56, an auxiliary cutout 54 is provided in the plate section 90 so that the lock spring 56 is replaced along with the nearby section.

A pin attaching hole 48 is provided on a rear corner of the ejector 50. A pin 60 has an ejector attaching section 62 for engagement with the pin attaching hole 48. Consequently, the pin 60 reciprocates along with the ejector 50 so that a heart cam engaging section 61 slides on a cam groove 66 of a heart cam mechanism 64 provided in the card insertion/removal direction. The cam groove 66 is made around a heart-shaped central island 67. The heart cam mechanism is conventional and its detailed description is omitted.

The cover 30 is made by stamping and bending a sheet of metal. A pair of depressing springs 40 are provided on the cover 30 to prevent the card 3 from jumping out of the connector 1 upon ejection. A first depressing spring 32 and a second depressing spring 34 are provided on the cover 30 to prevent the sliding pin 60 from being lifted up from the cam groove 66.

A first protective member 70, which is an extended portion of a top face 42 of the cover 30, is bent downwardly to cover at least a portion of the end face 13a of the side wall 12a. When a card is inserted at an angle, the strong metallic first protective member 70 abuts against the side wall 88 of the card to prevent damage to the housing 10. The first protective member 70 receives a force from the card 3 in the direction of arrow A (FIG. 1) so that it has a high withstanding power. In order to assure that the card 3 does not abut against the housing 10 but the first protective member 70, a side face 72 of the first protective member 70 is made flash with or beyond the inside face 14a of the side wall 12a at the end face 13a. When the first protective member 70 receives an impact from the side face 88 of the card 3 at the edge, insertion of the card by slip is also prevented.

A second protective member 71, which is an extended portion of a side face 43 of the cover 30, is bent laterally to cover at least a portion of the end face 13b of a side wall 12b. When a card is inserted at an angle, the side wall 87 of the card 3 does not abut against the housing 10 but the strong metallic second protective member 71, thus preventing damage to the housing 10. In order to assure that the side wall 87 of a card abuts against the second protective member 71, the end face 73 of the second protective member 71 is made flash with or beyond the inside face 14b of the side wall 12b at the end face 13b. As apparent from FIG. 5, when a card is inserted at an angle, the second protective member 71 receives a force from the inclined face 89 in the direction of arrow B where it has been bent and has satisfactory withstanding power against the card 3.

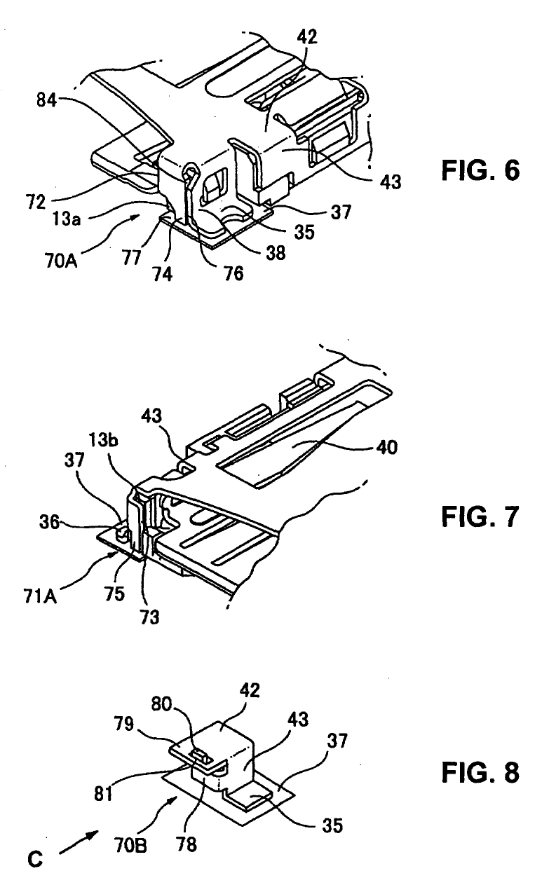

In FIG. 6, a first fixing means or free end 74 of the first protective member 70A extends to the board surface and soldered to the board 37 together with a soldering section 35 of the cover 30. Similarly, in FIG. 7, a second fixing means or free end 75 of the second protective member 71A is soldered to the board 37 together with a soldering section 36 of the cover 30. As a result, even if the card 3 is inserted upside down, deformation or breakup is prevented. A cutout 77 is provided in the first fixing means 74 to prevent solder from reaching such a position as to block sliding movement of the ejector 50. Even if the first protective member 70A is deformed toward the cover 30, the side edge 84 of the first protective member 70A abuts against the inside face of a front side 38 of the cover 30 with little or no gap at position 76 so that the fixing power of the first protective member 70 is increased.

In FIG. 8, a first protective member 70B according to the third embodiment is provided with a bent portion 78 to cover at least a portion of the housing where a card is inserted in the direction of arrow C. An extended section 79 extends from the top face 42 of the cover 30 and has an engaging hole 81 for receiving an engaging projection 80 of the bent section 78 so as to reinforce the bent section 78.

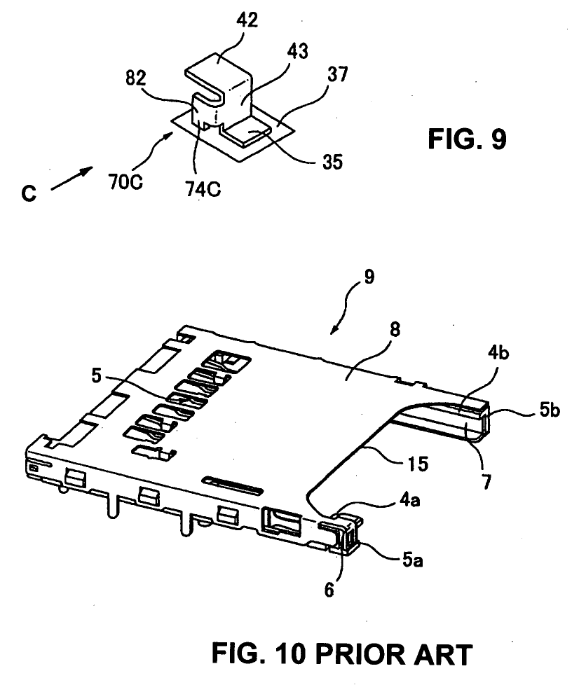

In FIG. 9, a first protective member 70C according to the fourth embodiment has a bent section 82 to cover at least a portion of the housing. In order to reinforce the bent section 82, the first protective member 70C has a fixing section 74C that is soldered to the board 37 together with the soldering section 35 of the cover 30. In this way, by providing the fixing section or engaging section, it is possible to reinforce the member that receives a force from pushing of the inclined card.

Referring back to FIG. 5, when the card 3 is inserted upside down, the front end of the card 3 abuts against the lock spring 56 of the ejector, and the side face 88 of the card 3 abuts against the spring abutment 58 or inclined card abutment 59 so that the card 3 is made inclined. At this point, the side section 72 of the first protective member 70 abuts against the side face 88 of the card 3 while the side section 73 of the second protective member 71 buts against the side face 87, especially, the inclined face 89 of the card 3 so that the operator notices the wrong insertion instantly and, thus, the wrong insertion of a card is prevented. When the side section 72 of the second protective member 71 abuts against the inclined face 89 of the card, a turning force is exerted on the card 3 so that the second protective member 71 may be made weaker than the first protective member 70 against which the straight side face 88 of the card 3 abuts. That is, at least the side wall 12a on the side of the inclined means is protected. Alternatively, only one of the first and second protective members, for example, only the first protective member 70 may be provided. The invention may be used widely for card connectors.

1. A card connector comprising:
a housing having a card insertion opening at its front end into which a card is inserted in a card insertion/removal direction;
a metal cover for covering top and side faces of said housing;
said housing having a pair of side walls extending in said card insertion/removal direction; and
said cover having a protective member at said card insertion opening for protecting at least a portion of a front end of at least one of said side walls.

2. The card connector according to claim 1, wherein said protective member has a first section extending from a top of said cover along said card insertion/removal direction and a second section bent downwardly from said first section.

3. The card connector according to claim 1, wherein said protective member has a first section extending from a side of said cover and a second section bent laterally toward said card insertion opening.

4. The card connector according to claim 2, wherein said protective member has a portion that is attachable to or engageable with another member.

5. The card connector according to claim 3, wherein said protective member has a portion that is attachable to or engageable with another member.

6. The card connector according to claim 1, wherein said card has an inclined face between a front narrow section and a rear wide section of said card;
said card connector further comprises an ejector that is able to slide in said housing in said card insertion/removal direction and normally biased toward said card insertion opening;
said ejector has an inclined face that corresponds to said inclined face of said card so that when said card is inserted correctly, it is inserted into said housing with said inclined face of said card fitting with said inclined face of said ejector while if said card is inserted upside down, said inclined face of said ejector abuts against another face of said card, making said card inclined and preventing wrong insertion of said card.

7. The card connector according to claim 2, wherein said card has an inclined face between a front narrow section and a rear wide section of said card;
said card connector further comprises an ejector that is able to slide in said housing in said card insertion/removal direction and normally biased toward said card insertion opening;
said ejector has an inclined face that corresponds to said inclined face of said card so that when said card is inserted correctly, it is inserted into said housing with said inclined face of said card fitting with said inclined face of said ejector while if said card is inserted upside down, said inclined face of said ejector abuts against another face of said card, making said card inclined and preventing wrong insertion of said card.

8. The card connector according to claim 3, wherein said card has an inclined face between a front narrow section and a rear wide section of said card;
said card connector further comprises an ejector that is able to slide in said housing in said card insertion/removal direction and normally biased toward said card insertion opening;
said ejector has an inclined face that corresponds to said inclined face of said card so that when said card is inserted correctly, it is inserted into said housing with said inclined face of said card fitting with said inclined face of said ejector while if said card is inserted upside down, said inclined face of said ejector abuts against another face of said card, making said card inclined and preventing wrong insertion of said card.

9. The card connector according to claim 4, wherein said card has an inclined face between a front narrow section and a rear wide section of said card;
said card connector further comprises an ejector that is able to slide in said housing in said card insertion/removal direction and normally biased toward said card insertion opening;
said ejector has an inclined face that corresponds to said inclined face of said card so that when said card is inserted correctly, it is inserted into said housing with said inclined face of said card fitting with said inclined face of said ejector while if said card is inserted upside down, said inclined face of said ejector abuts against another face of said card, making said card inclined and preventing wrong insertion of said card.

10. The card connector according to claim 5, wherein said card has an inclined face between a front narrow section and a rear wide section of said card;
said card connector further comprises an ejector that is able to slide in said housing in said card insertion/removal direction and normally biased toward said card insertion opening;
said ejector has an inclined face that corresponds to said inclined face of said card so that when said card is inserted correctly, it is inserted into said housing with said inclined face of said card fitting with said inclined face of said ejector while if said card is inserted upside down, said inclined face of said ejector abuts against another face of said card, making said card inclined and preventing wrong insertion of said card.
